(19) United States
(12) Patent Application Publication
(10) Pub. No.: US 2023/0217933 A1
(43) Pub. Date: Jul. 13, 2023

(54) USE OF CYANOBACTERIA AS A COVER CROP

(71) Applicant: BIODEL AG INC., MARICOPA, AZ (US)

(72) Inventors: GEORGE BENJAMIN CLOUD, MARICOPA, AZ (US); MICHAEL KIRKSEY, MARICOPA, AZ (US); KENT ADAMS, ORO VALLEY, AZ (US); PAUL ZORNER, ENCINITAS, CA (US)

(21) Appl. No.: 18/153,476

(22) Filed: Jan. 12, 2023

Related U.S. Application Data
(60) Provisional application No. 63/299,112, filed on Jan. 13, 2022.

(51) Int. Cl. A01N 65/03

(52) U.S. Cl. CPC A01N 65/03

(57) ABSTRACT

The subject invention provides microbial cover crops for the management of crops, soil, and water. More specifically, the invention provides for methods of using the microbe-based cover crop to address various soil quality issues, including those involving soil fertility and stability and water management. Furthermore, the microbial cover crops can be applied and maintained efficiently

### CROSS-REFERENCE TO RELATED APPLICATION

This application claims priority to U.S. Provisional Patent Application No. 63/299,112, filed Jan. 13, 2022, which is incorporated herein by reference in its entirety.

### BACKGROUND OF THE INVENTION

Agriculture production is an essential industrial operation for feeding the world's population and producing other valuable commodities. The production of crops is vital for producing foods, livestock feed, pharmaceuticals, textiles and structural materials. The agriculture industry, however, can experience hardships, costs and unpredictable yields based on the climate and various environmental and man-made influences.

For example, degradation and the associated reduced productivity of soil is a growing problem, particular for dryland soils. Certain types of soils can degrade over time (sometimes referred to as “subsidence”). Furthermore, dry surface soil can be eroded by wind.

Soil organic carbon (SOC) is an important component of soil matter and consists mainly of plant and animal tissue remains, live and expired microbial biomass, and the by-products of microbial processes, as well as organo-mineral complexes. Sequestration of SOC occurs when carbon is transferred from the atmosphere into the soil by way of plants or microbes and other organic materials, which are stored in the soil with a long mean residence time (MRT). SOC sequestration can be achieved by, for example, increasing plant growth, retaining above and below-ground plant biomass, promoting microbial soil populations in the plant rhizosphere that are fed by plant root exudates and whose accumulating ‘necromass’ contributes significantly to SOC accumulation, and/or protecting and stabilizing the SOC against erosion and decomposition.

Greenhouse gases (GHGs), particularly nitrous oxide, are emitted when organic and inorganic fertilizers are applied to the soil. These fertilizers are susceptible to loss by leaching and denitrification before crop uptake. Over-dependence and long-term use of certain chemical fertilizers, pesticides and antibiotics can alter soil ecosystems, reduce soil microbial diversity and health, reduce stress tolerance, increase the prevalence of resistant pests, and impede plant growth and vitality.

One further issue that can have drastic effects on the agriculture industry is water usage. In certain areas of the country, over farming, inappropriate tillage practices, over-industrialization and/or over-development are leading to a reduction in ground water and aquifer levels. In other areas, droughts can occur, leading to widespread water shortages and reduced crop yields. The amount of water required to irrigate large tracts of farmland, as well as the amount of water needed for drinking by livestock animals, necessitates increased water use efficiency, thereby decreasing the amount of water required to achieve a desired production level.

Cover crops are currently grown to manage the arable soil and maintain photosynthetic conversion of atmospheric carbon to support production of root exudates that in turn feed soil microbial population and SOC accumulation, particularly in non-growing seasons, and, instead of being harvested, can be used to improve the conditions of the soil. “No brown soil” is an emerging refrain for regenerative farming practices. At the conclusion of the growing season for a commercial crop, a cover crop can be planted and either killed, tilled into the soil, or retained before the next growing season. Traditional cover crops include plants, such as, for example, clover, beans, legumes, brassica species, “tillage” radish species, and numerous grass species. However, current conventional cover crops have not been broadly adopted as the seed can be expensive, the resulting biomass is thought to delay warming of the seed bed in spring, create harvesting issues, require synthetic herbicides to kill, and the plants are perceived to consume soil, water, and other resources.

The economic costs and environmental impacts of current methods of crop production continue to burden the sustainability of the agriculture industry. It can be difficult for a grower to detect, address and monitor the various paint points while also maximizing yields and revenue for a growing season. Thus, there is a need for improved and more cost-efficient cover crops.

### BRIEF SUMMARY OF THE INVENTION

The subject invention provides environmentally-friendly, microbial (micro) cover crops for the management of crops and soil. More specifically, the invention provides a cover crop that can be used to address various problems associated with crop production. This use of the “micro” cover crop can have one or more of the following benefits, for example:

(a) Enhancing plant health, growth and/or yields;

(b) Enhancing soil health through rebuilding of degraded soils , improving soil microbial health, and/or preventing degradation of soils;

(c) Reducing atmospheric greenhouse gas emissions;

(d) Enhancing soil sequestration of carbon;

(e) Reducing the amount of fertilizer needed;

(f) Reducing the amount of fertilizer runoff;

(g) Providing an economically efficient cover crop;

(h) Low water requirement;

(i) Reducing soil loss primarily by reducing or eliminating soil erosion;

(j) Ability to apply the cover crop aerially and/or with ground-based boom sprayers;

(k) Reducing the intensity and/or frequency of dust storms;

(l) Reducing dust generated during the growth and harvest of crop plants;

(m) Ability to apply to rangelands;

(n) Fixing atmospheric nitrogen;

(o) Enhancing phosphate solubility;

(p) Enhancing microbial growth and nutrient cycling;

(q) Enhancing soil moisture retention, precipitation/irrigation percolation, and reduction of water ‘run-off’;

(r) Flexible application and/or growth timing of the cover crop;

(s) Mitigating soil salinity;

(t) Enhancing soil aggregate formation;

(u) Reducing atmospheric particulates;

(v) Reducing agricultural costs;

(w) Reducing soil compaction;

(x) Enhancing breakdown of pesticide and herbicide residues; and

(y) Can be applied in applications where the solar effect of warming and cooling soil is necessary to support crop yield.

In preferred embodiments, the subject invention provides microbe-based soil treatment compositions, as well as methods that utilize these products. In certain embodiments, the invention utilizes microbial cultures, such as, for example, cyanobacterial cultures. Advantageously, in preferred embodiments the subject invention utilizes non-GMO microorganisms.

In certain embodiments, the soil treatment composition comprises one or more beneficial microorganisms. In preferred embodiments, the beneficial microorganisms are photosynthetic bacteria capable of being grown as a cover crop.

In preferred embodiments, the microorganism is a cyanobacteria, selected from, for example, Synechocystis, Synechococcus, Anabaena, Chroococcidiopsis, Cyanothece, Lyngbya, Phormidium, Nostoc, Spirulina, Arthrospira, Trichodesmium, Leptolyngbya, Plectonema, Myxosarcina, Pleurocapsa, Oscillatoria, Pseudanabaena, Cyanobacterium, Geitlerinema, Euhalothece, Calothrix, Tolypothrix, and Scytonema.

The species of microorganisms and other ingredients in the composition can be determined according to, for example, the geographic region where treatment will occur, environmental factors such as drought and/or flooding, the health status of the farmland or rangeland at the time of treatment, as well as other factors. Thus, the composition can be customized for any given location.

In one embodiment, the microbe-based soil treatment composition is applied to a tract of land, such as farmland, pastureland, rangeland, forest land, or tracts cleared by natural fire and prescribed burns, wherein the microbial composition provides one or more direct or indirect benefits to the plants and/or soil of the land.

These benefits include, for example, an economically efficient cover crop, improved retention and dispersion of water and/or nutrients in soil, reduced use of water for the growth of the cover crop, increased water penetration into deeper soil and aquifers, reduced erosion and degradation of soil; increased crop health, growth and yields; reduced over-fertilization and fertilizer runoff; improved nutrient solubilization and bioavailability; reducing the frequency and/or intensity of dust storms; efficient application of cover crops; application of cover crops to non-arable lands; and fixing nitrogen.

In one embodiment, the microbe-based composition can be applied to soil or land experiencing drought and/or aquifer depletion, particularly for use as a cover crop, wherein the soil treatment composition increases the wettability of soil, improves retention and dispersion of water in soil, improves the drainage and dispersion of pooling water in hydrophobic soils, reduces water loss due to evaporation, and/or increases water penetration into deeper soil layers and groundwater sources, such as aquifers. Accordingly, the methods can contribute to improved water use efficiency, improved drought management, and recharging of depleted aquifers.

The methods and compositions of the subject invention can be used either alone or in combination with additional components, such as herbicides, fertilizers, pesticides and/or other soil amendments. Preferably, the additional components are non-toxic and environmentally-friendly. The exact materials and the quantities thereof can be determined by, for example, a grower or soil scientist having the benefit of the subject disclosure.

The methods of the subject invention can utilize standard methods and equipment that are used for maintenance of farmland or other soil. For example, the soil treatment composition can be applied in liquid form using an irrigation system. The composition can also be applied as a granule, as a coating (e.g., seed coating), or impregnated into prills. Additionally, the composition can be applied using a manual spreader, such as a broadcast spreader, a drop spreader, a handheld spreader, or a handheld sprayer. The composition can also be applied using aerial spreading (e.g., crop dusting), by, for example, airplane, helicopter, or drone.

In some embodiments, the systems of the subject invention further involve the monitoring of various inputs and outputs of crop production. For example, following application of a microbe composition to a tract of land, factors such as water usage, soil moisture content and dispersion, fertilizer usage, soil salinity, soil nutrient content and dispersion, soil microbial populations, soil carbon content, generation of GHG emissions, fossil fuel usage, and plant growth, health and yields can be monitored. Accordingly, the composition can be adjusted throughout implementation to account for changes in these factors and make appropriate adjustments to the inputs for following seasons of use of the microbial compositions as cover crops.

In some embodiments, a central entity can serve as a general contractor, with sub-contractors performing one or more of the production, formulation/customization, transportation and application of the microbe compositions, as well as monitoring throughout the various growing seasons.

Advantageously, the systems of the subject invention can increase the efficiency and reduce the financial and environmental costs of agriculture practices. Additionally, the microbe-based cover crop represents an inexpensive cover crop. In particular, the compositions and methods utilized according to the subject invention can help in preserving both the amount and productivity of valuable natural resources, such as soil and water, while improving the production of valuable plant-based commodities.

### DETAILED DESCRIPTION OF THE INVENTION

The subject invention provides environmentally-friendly microbial compositions for the management of crops and soil. More specifically, the invention provides a cover crop that can be used to address various problems associated with crop production and/or improve crop health and/or yield.

In preferred embodiments, the use of the cover crop provides solutions to problems such as, for example, erosion and degradation of soil; reduced crop health, growth and yields; over-fertilization and fertilizer runoff; poor nutrient solubilization and bioavailability; expensive cover crops; high water usage; poor SOC content; excessive soil salinity, dust storms; inefficient application of cover crops; application of cover crops to non-arable lands; and fixing nitrogen.

### Selected Definitions

As used herein, “agriculture” means the cultivation and breeding of plants for food, fiber, biofuel, medicines, cosmetics, supplements, ornamental purposes and other uses. According to the subject invention, agriculture can also include horticulture, landscaping, gardening, plant conservation, forestry and reforestation, pasture and prairie restoration, ranching, dairy production, orcharding, arboriculture, and agronomy. Further included in agriculture are the care, monitoring and maintenance of soil.

As used herein, a “broth” or “culture broth,” or refers to a culture medium comprising at least nutrients and microorganism cells.

As used herein, the term “carbon use efficiency” or “CUE” refers to a generalized measure of the efficiency by which microbes allocate carbon taken up towards growth and biomass production versus respiration. CUE can be calculated as growth (biomass production) over the sum of CO₂ production/emissions and growth. Microorganisms are often categorized as “low CUE” or “high CUE,” where a CUE greater than 0.50 is considered high, and a CUE lower than 0.50 is considered low.

As used herein, “farmland” includes any tract of land in which plants are grown, cultivated and/or managed for human interests. Farmland includes: pastures, or land containing mostly grasses, legumes and non-grass herbaceous plants, that is grazed by livestock; meadows, which are typically ungrazed tracts of land that may be used for harvesting hay or other animal fodder; rangelands, which include untended and human-tended grasslands, shrublands, woodlands, wetlands and deserts that are grazed by domestic livestock or wild animals; and agricultural crops.

As used herein, “agricultural crops,” “crop plants,” or “cash crops” refer to any species of plant or alga, grown for profit and/or for sustenance for humans, animals or aquatic organisms, or used by humans (e.g., textile, cosmetics, and/or drug production), or viewed by humans for pleasure (e.g., flowers or shrubs in landscaping or gardens) or any plant or alga, or a part thereof, used in industry, commerce or education. Crop plants can be plants that can be obtained by traditional breeding and optimization methods or by biotechnological and recombinant methods, or combinations of these methods, including the transgenic plants and the plant varieties.

As used herein, the phrase “cover crops” refers to organisms that are grown on, or in, soil for the purpose of enhancing the soil conditions but are not intended to be harvested.

As used herein, a “biologically pure culture” is a culture that has been isolated from materials with which it is associated in nature. In a preferred embodiment, the culture has been isolated from all other living cells. In further preferred embodiments, the biologically pure culture has advantageous characteristics compared to a culture of the same microbe as it exists in nature. The advantageous characteristics can be, for example, enhanced production of one or more growth by-products.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

As used herein, “enhancing” means improving or increasing. For example, enhanced plant health means improving the plant's ability grow and thrive, which includes increased seed germination and/or emergence, and improved ability to survive environmental stressors, such as droughts and/or overwatering. Enhanced plant growth and/or enhanced plant biomass means increasing the size and/or mass of a plant above and/or below the ground (e.g., increased canopy/foliar volume, height, trunk caliper, branch length, shoot length, protein content, root size/density and/or overall growth index), and/or improving the ability of the plant to reach a desired size and/or mass. Enhanced yields mean improving the end products produced by the plants in a crop, for example, by increasing the number and/or size of fruits, leaves, roots and/or tubers per plant, and/or improving the quality of the fruits, leaves, roots and/or tubers (e.g., improving taste, texture, brix, chlorophyll content and/or color).

The subject invention utilizes “microbe-based compositions,” meaning a composition that comprises components that were produced as the result of the growth of microorganisms. Thus, the microbe-based composition may comprise the microbes themselves and, optionally, by-products of microbial growth. The microbes may be in a vegetative state, in spore (e.g., akinetes) heterocysts, or a mixture thereof. The microbes may be planktonic, in a biofilm form, or a mixture thereof. The by-products of growth may be, for example, metabolites, cell membrane components, proteins, and/or other cellular components. The microbes may be intact or lysed. In preferred embodiments, the microbes are present with growth medium in which they were grown in the microbe-based composition. The microbes may be present at, for example, a concentration of at least 1×10⁴, 1×10⁵, 1×10⁶, 1×10⁷, 1×10⁸, 1×10⁹, 1×10¹⁰, 1×10¹¹, 1×10¹² or 1×10¹³ or more CFU per gram or per ml of the composition.

The subject invention further provides “microbe-based products,” which are products that are to be applied in practice to achieve a desired result. The microbe-based product can be simply a microbe-based composition harvested from a microbe cultivation process. Alternatively, the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein “preventing” or “prevention” of a situation or occurrence means delaying, inhibiting, suppressing, forestalling, and/or minimizing the onset, extensiveness or progression of the situation or occurrence. Prevention can include, but does not require, indefinite, absolute or complete prevention, meaning it may still develop at a later time. Prevention can include reducing the severity of the onset of such a situation or occurrence, and/or stalling its development to a more severe or extensive situation or occurrence.

The term “Cyanobacterium” refers to a member from the group of photoautotrophic prokaryotic microorganisms that can utilize solar energy and fix carbon dioxide. Cyanobacteria are also referred to as blue-green algae. Bacterial genera suitable for use according to the current invention, include Synechocystis, Synechococcus, Anabaena, Chroococcidiopsis, Cyanothece, Lyngbya, Phormidium, Nostoc, Spirulina, Arthrospira, Trichodesmium, Leptolyngbya, Plectonema, Myxosarcina, Pleurocapsa, Oscillatoria, Pseudanabaena, Cyanobacterium, Geitlerinema, Euhalothece, Calothrix, Tolypothrix and Scytonema.

As used herein, a “biofilm” is a complex aggregate of microorganisms, such as bacteria, wherein the cells adhere to each other and/or to a surface. The cells in biofilms are physiologically distinct from planktonic cells of the same organism, which are single cells that can float or swim in liquid medium.

A “metabolite” refers to any substance produced by metabolism (e.g., a growth by-product) or a substance necessary for taking part in a particular metabolic process. A metabolite can be an organic compound that is a starting material, an intermediate in, or an end product of metabolism. Examples of metabolites can include, but are not limited to, enzymes, toxins, acids, solvents, alcohols, proteins, carbohydrates, vitamins, minerals, microelements, amino acids, polymers, and surfactants.

As used herein, “water use efficiency,” or “WUE,” refers to the ratio of yields and/or biomass produced per unit of water applied. According to the subject invention, WUE can refer to the measure of plant yields/biomass, as well as animal yields/biomass (e.g., carcass weight) produced per unit of water applied.

As used herein, “surfactant” refers to a compound that lowers the surface tension (or interfacial tension) between phases. Surfactants act as, e.g., detergents, wetting agents, emulsifiers, foaming agents, and dispersants. A “biosurfactant” is a surfactant produced by a living organism and/or using naturally-derived substrates.

As used herein the phrases or terms “soil crust,” “biological soil crust,” or biocrust” refer to the uppermost layer of soil that is formed by communities of microorganisms and/or macroorganisms, including, for example, lichens, mosses, bacteria (including cyanobacteria), algae, and/or fungi. These soil crusts are particularly present in arid or dryland ecosystems.

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduction” refers to a negative alteration, and the term “increase” refers to a positive alteration, wherein the negative or positive alteration is at least 0.25%, 0.5%, 1%, 5%, 10%, 15%, 20%, 25%, 30%, 35%, 40%, 45%, 50%, 55%, 60%, 70%, 75%, 80%, 85%, 90%, 95%, or 100%.

As used herein, “reference” refers to a standard or control condition.

As used herein, a “soil amendment” or a “soil conditioner” is any compound, material, or combination of compounds or materials that are added into soil to enhance the properties of the soil. Soil amendments can include organic and inorganic matter, and can further include, for example, fertilizers, pesticides and/or herbicides. Nutrient-rich, moist, low saline, microbially-rich, appropriate SOC, well-draining soil is essential for the growth and health of plants, and thus, soil amendments can be used for enhancing the plant biomass by altering the nutrient, salinity, microbial content SOC content, and moisture content of soil. Soil amendments can also be used for improving many different qualities of soil, including but not limited to, soil structure (e.g., aggregate content and preventing compaction); improving the nutrient concentration and storage capabilities; improving water retention in dry soils; and improving drainage in waterlogged soils.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially” of the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof. All references cited herein are hereby incorporated by reference in their entirety.

### Cover Crop Systems for Improving Agriculture

The subject invention provides environmentally-friendly cover crops for the management of crops and soil, particularly dryland soils. More specifically, the invention provides a cover crop that can be used to address various problems associated with crop production. This use of the cover crop can have one or more of the following benefits, for example:

(a) Enhancing plant health, growth and/or yields;

(b) Enhancing soil health through rebuilding of degraded soils, improving soil health, and/or preventing degradation of soils;

(c) Reducing atmospheric greenhouse gas emissions;

(d) Enhancing soil sequestration of carbon;

(e) Reducing the amount of fertilizer needed;

(f) Reducing the amount of fertilizer runoff;

(g) Economically efficient cover crop;

(h) Low water requirement;

(i) Reducing soil loss primarily by reducing or eliminating soil erosion;

(j) Ability to apply the cover crop aerially or with ground-based boom or other spray delivery systems;

(k) Reducing the intensity and/or frequency of dust storms;

(l) Reducing dust generated during the growth and harvest of crop plants;

(m) Ability to apply to rangelands;

(n) Fixing atmospheric nitrogen;

(o) Enhancing phosphate solubility;

(p) Enhancing microbial growth and nutrient cycling;

(q) Enhancing soil moisture retention, precipitation/irrigation percolation and reduction of water ‘run-off’;

(r) Flexible application and/or growth timing of the cover crop;

(s) Mitigating soil salinity;

(t) Enhancing soil aggregate formation;

(u) Reducing atmospheric particulates;

(v) Reducing agricultural costs;

(w) Reducing soil compaction;

(x) Enhancing breakdown of pesticide and herbicide residues; and

(y) Can be applied in applications where the solar effect of warming and cooling soil is necessary to support crop yield.

The subject invention can be used to achieve any one or a combination of any number of the above-listed goals. In some embodiments, some of the above goals over-lap one another such that achieving one, e.g., goal (b), will also help in achieving another, e.g., goal (e). In preferred embodiments, the subject invention provides microbe-based soil treatment compositions, as well as methods that utilize these products. Advantageously, in preferred embodiments, the subject invention utilizes organic, non-GMO components.

In one embodiment, a unit tract of land, such as an acre or any other unit, is monitored to evaluate the attainment of the goal(s). Preferably, the monitoring is quantitative. In one embodiment, carbon credits are earned as well as other current or future environmental benefits market where growers are compensated for engaging regenerative and/or environmentally sustainable practices that sequester soil carbon but also conserve water, reduce inorganic fertilizer use, runoff of fertilizers and pesticides to sensitive environments and/or in which the carbon intensity (such as described by the Argonne GREET model) is reduced, neutral, or even negative.

In certain embodiments, the soil treatment composition comprises one or more beneficial microorganisms. In preferred embodiments, the beneficial microorganisms are non-pathogenic, cyanobacteria capable of producing exopolysaccharides that can facilitate soil aggregation. Soil aggregates provide pores for water to infiltrate the soil and provide sinks of organic carbon matter.

The species and ratio of microorganisms and other ingredients in the composition can be determined according to, for example, the geographic region where treatment will occur, environmental factors such as drought and/or flooding, the species of plants and/or harvested products thereof, the health status of the soil at the time of treatment, as well as other factors. Thus, the composition can be customized for any given location.

In certain exemplary embodiments, the soil treatment composition comprises a single species of cyanobacteria and, optionally, growth by-products thereof and, optionally, one or more sources of nutrients.

In certain exemplary embodiments, the soil treatment composition comprises a first microorganism, a second microorganism, a third microorganism, a fourth microorganism, or any combination thereof, and, optionally, one or more sources of nutrients. In a specific exemplary embodiment, the first microorganism is a Nostoc spp., the second microorganism is a Spirulina spp., the third microorganism is a Tolypothrix spp., and the fourth microorganism is an Anabaena spp.

In certain exemplary embodiments, the soil treatment composition comprises microbial growth by-products, which can include, for example, the growth medium in which the microbes were cultivated, and/or any leftover nutrients from cultivation. The cells may remain in the medium, removed entirely from the medium, and/or removed to a point where only residual cellular matter remains in the medium. The growth by-products can also comprise metabolites or other biochemicals produced as a result of cell growth, including, for example, exopolysaccharides and biosurfactants.

In one embodiment, the microbe-based soil treatment composition is applied to a tract of land, such as farmland, pastureland, rangeland, forest land, or tracts cleared by natural fire and prescribed burns, wherein the soil treatment composition provides one or more direct or indirect benefits to the plants and/or soil of the land, which contribute to improving crop production.

In one embodiment, the microbe-based soil treatment composition is applied to soil or land experiencing drought, wherein the soil treatment composition increases the wettability of soil, improves retention and dispersion of water in soil, improves the drainage and dispersion of pooling water in hydrophobic soils, reduces water loss due to evaporation, and/or increases water penetration into deeper soil layers and groundwater sources, such as aquifers. Accordingly, the methods can contribute to improved water use efficiency, improved drought management, and recharging of depleted aquifers.

In certain embodiments, the use of a microbe-based cover crop can provide an economic advantage compared to traditional cover crops. The microbe-based cover crop can be less expensive to, for example, create an inoculum for application to the soil, transport the inoculum, apply the inoculum, maintain the cover crop, and/or process the soil for future crop plant growth. In certain embodiments, the use of a microbe-based cover crop can eliminate or reduce the need for a traditional cover crop. In certain embodiments, the microbe-based cover crop can reduce the costs associated with agricultural practices, including, for example, labor costs, fuel costs, machinery cost, land costs, and/or fertilizer costs.

The methods can further comprise applying materials to enhance microbe, plant, and/or soil health during application. In one embodiment, these additional materials can include, for example, multiple sources and forms of magnesium, phosphate, nitrogen, potassium, selenium, calcium, sulfur, iron, copper, zinc, other minerals, proteins, vitamins and/or various forms of organic carbon.

The methods and compositions of the subject invention can be used either alone or in combination with additional components, such as herbicides, pesticides, soil amendments and/or fertilizers. Preferably, the additional components are non-toxic and environmentally-friendly. The exact materials and the quantities thereof can be determined by, for example, a grower or soil scientist having the benefit of the subject disclosure. In certain embodiments, the additional component can be humic, molasses, yeast, soy protein isolates, growth supporting minerals, zinc, magnesium, complex sugars, chicken manure, or any combination thereof

### Modes of Application

As used herein, “applying” a composition or product to a site refers to contacting a composition or product with a site such that the composition or product can have an effect on that site. The effect can be due to, for example, microbial growth and colonization, and/or the action of a metabolite, enzyme, biosurfactant or other microbial growth by-product, and/or activity of an accelerator substance. The mode of application depends upon the formulation of the composition, and can include, for example, spraying, pouring, sprinkling, injecting, spreading, mixing, dunking, fogging and misting. Formulations can include, for example, liquids, dry and/or wettable powders, flowable powders, dusts, granules, pellets, emulsions, microcapsules, gels, pastes and/or aerosols. In an exemplary embodiment, the subject soil treatment composition is applied after the composition has been prepared by, for example, mixing the composition with water.

In one embodiment, the site to which the composition is applied is the soil in which plants will be planted or are growing (e.g., a crop, a field, an orchard, a grove, a pasture/prairie or a forest). In preferred embodiments, the composition can be applied after a growing season of a crop plant. In certain embodiments, the composition provides a microbial inoculum that initiates the growth of microbe as a cover crop in soil. The microbe can be grown for the entirety of the off-season for the crop plant or for a portion of the off-season for the crop plant. In certain embodiments, the microbe can be grown in place of a crop plant, such as, for example, for use in a crop rotation. In certain embodiments, before the growing season of the crop plant or the planting of the crop plant, the microbe can be killed, using, for example, an antibiotic. Alternatively, the microbe can be tilled into the soil or the plant can be grown directly in the place of microbe without any treatment performed on the soil or microbe before the growing season of the crop plant or the planting of the crop plant.

The compositions of the subject invention can be pre-mixed with irrigation fluids, wherein the compositions percolate through the soil and can be delivered to, for example, the soil. Alternatively, the compositions can be applied aerially. In one embodiment, the compositions are applied to soil surfaces, with or without water, where the beneficial effect of the soil application can be activated by rainfall, sprinkler, flood, or drip irrigation. In certain embodiments, the microbe-based cover crop requires less water than a traditional cover crop.

In one embodiment, the composition is applied to a plant or plant part, particularly a cover crop plant. The composition can be applied directly thereto as a seed treatment, or to the surface of a plant or plant part (e.g., to the surface of the roots, tubers, stems, flowers, leaves, fruit, or flowers). In a specific embodiment, the composition is contacted with one or more roots of the plant. The composition can be applied directly to the roots, e.g., by spraying or dunking the roots, and/or indirectly, e.g., by administering the composition to the soil in which the plant grows (or the rhizosphere). The composition can be applied to the seeds of the plant prior to or at the time of planting, or to any other part of the plant and/or its surrounding environment. In certain embodiments, the plant is a cover crop, such as, for example clover, beans, and grasses. In certain embodiments, microbe-based cover crops of the subject invention and traditional cover crops, including, for example, clover, legumes, brassica species, “tillage” radish species, and numerous grass species, can be grown in the same location at the same time.

In certain embodiments, the composition can be applied with other microorganisms including algae, such as for example, Chlorella spp., Chlamydomonas spp., Dunaliella spp., Bracteacoccus spp., or Prasinoderma spp.; or non-pathogenic bacterium, yeast and/or fungus selected from, for example, Trichoderma spp., Bacillus spp., Paenibacillus macerans, Paenibacillus azotofixans (Paenibacillus durus), Beijerinckia spp., Wickerhamomyces anomalus, Myxococcus xanthus, Pseudomonas chlororaphis, Starmerella bombicola, Saccharomyces boulardii, Pichia occidentalis, Pichia kudriavzevii, Meyerozyma guilliermondii, mycorrhizal fungi, nitrogen fixers (e.g., Azotobacter vinelandii) and/or potassium mobilizers (e.g., Frateuria aurantia).

In one embodiment, wherein the method is used in a large-scale setting, such as in a crop, a muck field, a citrus grove, a pasture or prairie, a forest, a sod or turf farm, or another agricultural crop, the method can comprise administering the composition into a tank connected to an irrigation system used for supplying water, fertilizers, pesticides or other liquid compositions. Thus, the soil can be treated with the composition via ground application, for example, foliar application, soil injection, soil drenching, using a center pivot irrigation system, with a spray over the seed furrow, with micro-jets, with drench sprayers, with boom sprayers, with sprinklers and/or with drip irrigators or via aerial application, for example, with aerial sprayers. Advantageously, the method is suitable for treating hundreds or more acres of land.

In one embodiment, wherein the method is used in a smaller scale setting, the method can comprise pouring the composition (mixed with water and other optional additives) into the tank of a handheld lawn and garden sprayer and spraying soil or another site with the composition. The composition can also be mixed into a standard handheld watering can and poured onto a site.

In one embodiment, specific nutrients in various forms are added to and/or applied concurrently with the microbe-based product to enhance microbial inoculation and growth. These can include, for example, nitrates, sulfates, potassium, calcium, sodium, magnesium, sulfur, boron, iron, manganese, molybdenum, copper, cobalt, zinc, and/or other minerals. The nutrients can be derived from, for example, sodium nitrate, dipotassium phosphate, magnesium sulfate, calcium chloride, citric acid, ferric ammonium citrate, EDTA disodium salt, sodium carbonate, boric acid, manganese chloride, zinc sulfate, sodium molybdate, copper sulfate, cobalt nitrate, or BG-11 media or any component thereof.

In certain preferred embodiments, the method can comprise applying the composition to soil. Soil can be treated at any point during the process of cultivating the plant. For example, the composition can preferably be applied at any point after the harvest of the plant or product thereof, including after the plant has flowered, fruited, and after abscission of leaves.

In certain embodiments, the method can comprise applying the composition to soil in which traditional cover crop are unable to be grown, such as, for example, at locations under or near drip line or at locations that are sensitive to temperature, such as, for example, locations in which traditional cover crops would reduce the soil temperature in an orange orchard by providing shade.

### Crop Management

The subject compositions and methods can be useful for enhancing plant health, growth and/or yields; enhancing sequestration of carbon in soil, vegetation and microbial biomass; reducing fertilizer usage and waste; and/or increasing the availability of fixed nitrogen.

In one embodiment, methods are provided for enhancing plant health, growth and/or yields wherein one or more microorganisms is contacted with a tract of land in which plants are grown. The method can comprise applying a soil treatment composition of the subject invention.

In certain embodiments, the microorganisms of the composition work synergistically with one another to enhance health, growth and/or yields in plants.

In one embodiment, the method can enhance plant health, growth and/or yields by enhancing nutrients and the valency form of those nutrients that improves their plant uptake and availability in the soil. More specifically, in one embodiment, the methods can be used to improve the properties of the soil, for example, the nutrient and/or moisture retention and dispersion properties. In certain embodiments, the methods can be used to improve the percolation of precipitation or irrigation into soil, which can reduce water run-off.

In some embodiments, the subject methods can increase the above- and below-ground biomass of harvested plants or products thereof, which includes, for example, increased foliage volume, increased stem and/or trunk diameter, increased fruit or seed growth and/or density, enhanced root growth and/or density, and/or increased total numbers of plants.

Advantageously, in certain embodiments, the subject methods can be used to enhance health, growth and/or yields in plants having been affected by an environmental stressor, such as, for example, drought.

The present invention can be used to enhance health, growth and/or yields of plants and/or crops in, for example, agriculture, horticulture, greenhouses, and landscaping. The present invention can also be used for improving one or more qualities of soil, thereby enhancing the performance of the soils for agricultural, home and gardening purposes. Furthermore, the present invention can be used in pasture management, as well as in professional turf, ornamental and landscape management.

In certain embodiments, the soil treatment composition may also be applied so as to establish or enhance the growth of nutrient-fixing microbes, such as, for example, Anabaena spp. and Nostoc spp., as well as other beneficial endogenous and exogenous microbes, and, optionally, their by-products that promote crop growth, health and/or yield.

In certain embodiments, the subject method enhances plant utilization and storage of carbon. In addition to enhancing plant utilization and storage of carbon, colonization of the soil by the microbes of the subject composition can also increase soil carbon sequestration. In certain embodiments, increasing soil carbon sequestration is achieved by enhancing the growth of plant roots in the soil and/or increasing accumulation of aggregate organic matter in the soil.

In one embodiment, the methods and compositions according to the subject invention lead to an increase in one or more of: root length, root density, root mass, stalk diameter, plant height, canopy density, chlorophyll content, flower count, bud count, bud size, bud density, leaf surface area, oil content, fruit count, fruit size, fiber content, and/or nutrient uptake of a plant, by at least 1%, 5%, 10%, 20%, 30%, 40%, 50%, 60%, 70%, 80%, 90%, 100%, 150%, 200%, or more, compared to a plant growing in an untreated environment.

In certain embodiments, the subject compositions and methods can be used for improving agricultural fertilization practices. For example, in preferred embodiments, the microbes of the soil treatment composition can fix and/or aggregate nutrients in soil to provide enhanced solubilization of nutrients in the soil, such that the nutrients are more bioavailable for plant root uptake, including, for example, phosphates. In specific embodiments, compounds synthesized by the microbes can be aggregate nutrients, including, for example, exopolysaccharides and biosurfactants. These embodiments can also result in reduced soil salinity. In certain embodiments, the subject compositions and methods can be used for enhanced nutrient cycling, such as, for example, carbon, sulfur, nitrogen, water, phosphorus, and oxygen cycling, in which the various minerals or chemical compounds are available for use for growing crop plants.

In some embodiments, the subject invention can be used to reduce and/or replace a chemical or synthetic fertilizer, wherein the composition comprises a microorganism capable of fixing, solubilizing, mobilizing and/or increasing the bioavailability and/or root uptake of nitrogen and/or other micronutrients in soil, such as, e.g., S, Zn, B, Mg, and Mn. In other words, the subject invention can be useful for improving nutrient use efficiency and/or treating/preventing plant nutrient deficiencies.

In one embodiment, the method can be used for enhanced fixed nitrogen availability for cash crops. In some embodiments, microbes such as Anabaena spp. and Nostoc spp. can fix nitrogen. Thus, in some embodiments, improved nitrogen use efficiency, reduced nitrous oxide emissions, and reduced nitrogen runoff into water sources can be achieved by replacing some or all nitrogen-rich fertilizers and/or increasing soil nitrogen uptake by plant roots using soil treatment compositions according to the subject invention.

### Soil Management

The subject compositions and methods can be useful for enhancing soil health through the rebuilding of degraded soils, improving SOC, prevention of soil degradation, reducing soil erosion, improving dispersion of water, nutrients and salts in soil, reducing soil salinity, enhanced nitrogen fixation, and reducing the intensity and/or frequency of dust storms.

In certain embodiments, the subject invention can be used to enhance any number of qualities in any other type of soil, for example, clay, sandy, silty, peaty, chalky, loam soil, and/or combinations thereof. Furthermore, the methods and compositions can be used for improving the quality of dry, waterlogged, porous, depleted, compacted soils and/or combinations thereof.

The methods can be utilized in, for example, agricultural fields, pastures, orchards, prairies, plots, rangelands, drylands, and/or forests. The methods can also be utilized in areas containing soil that is significantly uninhabitable by plant life, for example, soils that have been over-cultivated and/or where crop rotation has not been implemented or has been insufficient to retain the soil's fertility; soils that have eroded or subsided; soils that have been polluted by over-treatment with pesticides, fertilizers and/or herbicides; soils with high salinity; soils that have been polluted by dumping, or chemical or hydrocarbon spills; and/or soils in areas damaged by natural or anthropogenic causes, including fire, flooding, pest infestation, development (e.g. commercial, residential or urban building), digging, mining, logging, livestock rearing, and other causes.

Advantageously, the methods can help enhance agricultural yields, even in depleted or damaged soils; restore depleted greenspaces, such as drylands, pastures, forests, wetlands and prairies; and restore uncultivatable land so that it can be used for farming, reforestation and/or natural regrowth of plant ecosystems.

In certain embodiments, the methods comprise a step of characterizing the soil type and/or soil health status prior to treating the soil according to the subject methods. Accordingly, the method can also comprise tailoring the composition in order to meet a specific soil type and/or soil health need. Methods of characterizing soils are known in the agronomic arts.

In some embodiments, the microorganisms of the soil treatment composition colonize the soil and convert carbon dioxide into carbon-rich microbial biomass and necromass.

In certain embodiments, the subject methods enhance SOC sequestration via, for example, increased above- and below-ground plant biomass, increased microbial biomass and/or necromass, and/or increased size and/or stability of soil aggregates. Furthermore, in certain embodiments, the methods can slow and/or stop soil profile degradation and/or erosion in areas where soil subsidence is occurring, including for example, in locations that experience dust storms. The subject methods can reduce the intensity and/or prevalence of dust generated during agricultural operations, such as, for example, during harvesting, or dust storms by stabilizing soil and/or retaining water in the soil. Preferably, in some embodiments, the methods can increase the depth of the soil profile, such as, for example, increasing the depth of a soil crust. In certain embodiments, the methods can establish a soil crust and/or biofilm, particularly of dryland soil.

Additionally, in certain embodiments, the subject methods can reduce the soil-borne emission of greenhouse gases, such as carbon dioxide, methane and nitrous oxide, which are caused by, for example, the decomposition of soil by low carbon use efficiency (CUE) microbes.

In some embodiments, the methods are used in combination with existing soil preservation practices, such as no-till or low-till farming, crop rotation, and/or the planting of other off-season cover crops. In certain embodiments, microbe-based cover crops of the subject invention and traditional cover crops, including, for example, clover, legumes, brassica species, “tillage” radish species, and numerous grass species, can be grown in the same location at different times.

Advantageously, the subject compositions and methods can help re-build soil resources that are traditionally considered non-renewable, while suppressing and/or averting soil GHG emissions and reducing the need for synthetic fertilizers.

In certain embodiments, the compositions and methods of the subject invention can be used for removing pollutants from soil, improving the nutrient content and availability of soil, improving drainage, dispersion and/or moisture retention properties of soil, improving nutrient retention and/or dispersion in soil, and/or improving the diversity of the soil microbiome. Other improvements can include adding bulk and/or structure to soils that have been eroded by wind and/or water, as well as preventing and/or delaying erosion of soil by wind and/or water.

Microbial biomass, whether active or inactive, provides organic matter that improves the physical structure of soils by, for example, adding bulk; helps reduce the erosion of soils by water and wind; and can increase the water retention capacity of soil, particularly dryland soils. Furthermore, active and decaying microbial biomass stimulates the formation of soil aggregates and improves the aeration, and thus water/nutrient infiltration, of heavy and compacted soils.

Other benefits of microbial biomass to soil include providing a nutrient source (e.g. nitrogen, phosphorus, potassium, sulfur, etc.) for plants as well as other soil microorganisms, dissolution of insoluble soil minerals to increase their bioavailability to plant roots due to, for example, favorable cation exchange capacity, regulation of soil temperature, and buffering of pesticide, herbicide, and other heavy metal residues.

In certain embodiments, the method results in removal and/or reduction of pollutants from soil, including remediation of soils contaminated with hydrocarbons. In some embodiments, the pollutants are degraded directly by the applied microorganisms of the composition. In some embodiments, the growth by-products of the microorganisms, e.g., biosurfactants and exopolysaccharides, facilitate degradation of the pollutants, and can chelate and form a complex with ionic and nonionic metals to release them from the soil. Soil pollutants include, for example, residual fertilizers, pesticides, herbicides, fungicides, hydrocarbons, chemicals (e.g., dry cleaning treatments, urban and industrial wastes), benzene, toluene, ethylbenzene, xylene, and heavy metals.

In some embodiments, the microbial growth by-products, such as biosurfactants, serve as emulsifiers, increasing the oil-water interface of hydrocarbon pollutants by forming stable microemulsions with them. The result is an increase in the mobility and bioavailability of the pollutants for decomposing microorganisms.

The methods can further comprise supplying oxygen and/or nutrients to the microorganisms by circulating aqueous solutions through the soils, thus stimulating the applied microorganisms, as well as naturally occurring soil microorganisms, to degrade the pollutants and/or produce pollutant-degrading growth by-products. In some embodiments, the polluted soil is combined with nonhazardous organic amendments such as manure or agricultural wastes. The presence of these organic materials supports the development of a rich microbial population and elevated temperature characteristics of composting. Thus, the rate of bioremediation can be increased.

In some embodiments, the microbial growth by-products, such as exopolysaccharides and biosurfactants, serve as aggregates, improving soil stability and water infiltration. The result is an increase in the mobility and bioavailability of the nutrients soil. In certain embodiments, the microbial growth by-products comprise amino acids, including, for example, histidine, isoleucine, leucine, lysine, methionine, phenylalanine, threonine, tryptophan, and valine.

The methods can further comprise supplying carbon dioxide and/or other carbon sources to the microorganisms by circulating aqueous solutions through the soils, thus increasing the growth rate of the applied microorganisms, to increase carbon sequestration and/or nutrient retention.

In certain embodiments, the method results in improved salinity of soil by reducing the salt content. Saline soils contain sufficient neutral soluble salts to adversely affect the growth of most crop plants. Soluble salts most commonly present are the chlorides and sulfates of sodium, calcium and magnesium. Nitrates may be present rarely, while many saline soils contain appreciable quantities of gypsum (CaSO₄, 2H₂O).

When leached with low-salt water, some saline soils tend to disperse, resulting in low permeability to water and air, particularly when the soils are heavy clays. The presence of microorganisms, exopolysaccharides, and/or biosurfactants improves the mobility of salts and/or ions, thereby facilitating drainage of salts into depths below plant root zones.

In certain embodiments, the methods can also help improve soil microbiome diversity by promoting colonization of the soil with beneficial soil microorganisms. Growth of nutrient-fixing microbes, such as Anabaena spp. and Nostoc spp., can be promoted or established, as well as other endogenous and applied microbes, thereby increasing the number of different species within the soil microbiome.

In one embodiment, the methods and compositions according to the subject invention lead to an increase in SOC in an area of soil, by at about 1%, about 5%, about 10%, about 20%, about 30%, about 40%, about 50%, about 60%, about 70%, about 80%, about 90%, about 100%, about 150%, about 200%, or more, compared to similar untreated areas.

In one embodiment, the methods and compositions according to the subject invention lead to an increase in depth of a soil crust, particularly in a dryland environment, by at least about 1%, about 5%, about 10%, about 20%, about 30%, about 40%, about 50%, about 60%, about 70%, about 80%, about 90%, about 100%, about 150%, about 200%, or more, compared to similar untreated areas.

In one embodiment, the methods and compositions according to the subject invention lead to a decrease in soil-borne emissions of GHG, such as CO₂, N₂O and/or CH₄, or atmospheric particulates by at least about 1%, about 5%, about 10%, about 20%, about 30%, about 40%, about 50%, about 60%, about 70%, about 80%, about 90%, about 100%, about 150%, about 200%, or more, compared to similar untreated areas.

### Water Management

In certain embodiments, the subject compositions and methods can be used for improving WUE in soil, which can also reduce the total water consumption for agricultural purposes.

In certain embodiments, crop WUE can be improved via improved soil water retention due to increased microbial biomass and necromass in soil, which serves as a “sponge.” In certain embodiments, increased soil-mineral aggregates can also facilitate water retention via, for example, ionic interactions. Advantageously, in some embodiments, the methods help reduce agricultural water consumption, even in drought.

In certain embodiments, microbial biosurfactants or exopolysaccharides can decrease the tendency of water to pool, improve the adherence or wettability of soil, resulting in more thorough hydration of soil. This is particularly useful in the case of flood irrigation methods, which can lead to pooling water that stands on the surface and evaporates. Improved wettability also promotes better root system health, as there are fewer zones of desiccation (or extreme dryness) inhibiting proper root growth and better availability of applied nutrients as chemical and micro-nutrients are more thoroughly made available and distributed.

The more uniform distribution of water in soil made possible by enhanced wettability also prevents water from accumulating or getting trapped above optimal penetration levels, thereby mitigating anaerobic conditions that inhibit the free exchange of oxygen and carbon. When the composition is applied, a more porous or breathable soil is established.

In one embodiment, the methods and compositions according to the subject invention lead to a decrease in water consumption and/or an increase in WUE for crop plant production by at least 1%, 5%, 10%, 20%, 30%, 40%, 50%, 60%, 70%, 80%, 90%, 100%, or more, compared to similar untreated soils.

In certain embodiments, the treatment composition comprises a microorganism that produces a biosurfactant and/or exopolysaccharide. Similar to the benefits provided to crops, the amphiphilic properties of biosurfactants of exopolysaccharides can enhance the dispersion of water throughout the soil. By improving the wettability of soil, the soil is more receptive to water so that the water is less likely to pool and/or evaporate in warmer weather. Instead, the water can penetrate the soil, including soils that are hydrophobic by nature, or have become hydrophobic.

### Reducing the Carbon Footprint and/or Carbon Intensity

A “carbon footprint” may be defined herein as a measure of the total amount of carbon dioxide (CO₂) and other GHGs emitted directly or indirectly by a human activity or accumulated over the full life cycle of a product or service. As just one example, a product that requires transportation over many miles by truck (e.g., harvested feed grains) may have a larger carbon footprint than an alternative product that does not require transportation (e.g., grass growing in a pasture).

Carbon footprints can be calculated using a Life Cycle Assessment (LCA) method, the Argonne GREET model, or can be restricted to the immediately attributable emissions from energy use of fossil fuels. An LCA, also known as life cycle analysis, ecobalance, and cradle-to-grave analysis) is the investigation and valuation of the environmental impacts of a given product or service caused or necessitated by its existence. The life cycle concept of the carbon footprint means that it is all-encompassing and includes all possible causes that give rise to carbon emissions. In other words, all direct (on-site, internal) and indirect emissions (off-site, external, embodied, upstream, downstream) need to be taken into account.

Normally, a carbon footprint is expressed as a CO₂ equivalent or in some markets as a carbon intensity (CI) score. Carbon dioxide equivalency is a quantity that describes, for a given mixture and amount of GHG, the amount of CO₂ that would have the same global warming potential (GWP), when measured over a specified timescale (generally, 100 years). Carbon dioxide equivalency thus reflects time-integrated radiative forcing. The carbon dioxide equivalency for a gas is obtained by multiplying the mass and the GWP of the gas. The following units are commonly used:

a) By the UN climate change panel IPCC: billion metric tonnes of CO₂ equivalent (GtCO₂ eq);

b) In industry: million metric tonnes of carbon dioxide equivalents (MMTCDE);

c) For vehicles: g of carbon dioxide equivalents/km (gCDE/km).

For example, the GWP for methane is 21 and for nitrous oxide 310. This means that emissions of 1 million metric tonnes of methane and nitrous oxide respectively is equivalent to emissions of 21 and 310 million metric tonnes of carbon dioxide.

Various methods exist in the art for calculating or estimating carbon footprints and may be employed in the subject invention.

Advantageously, in preferred embodiments, the subject invention can be useful for reducing the carbon footprint of producing agricultural products, which includes reducing the carbon footprint and CI score of producing forage-based, fodder-based and/or grain-based feed for livestock.

A “reduced carbon footprint” means a negative alteration in the amount of carbon dioxide and other GHGs emitted per unit time over the full life cycle of producing an agricultural product, through and until an agricultural product is ultimately consumed by human consumers. The negative alteration in CO₂ and/or other GHG emissions can be, for example, at least 0.25%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

In some embodiments, the term “carbon footprint” is interchangeable herein with the terms “carbon intensity” and “emission intensity.” Emission intensity is the measure of the emission rate of a given GHG relative to the “intensity” of a specific activity or industrial process (e.g., burning of fuel or the production of corn). The emissions intensity can include emission amount relative to, for example, amount of fuel combusted, yield of corn harvested, amount of a commercial product produced, total distance traveled, and/or number of economic units generated.

Emissions intensity is measured across the entire life cycle of a product. For example, the emissions intensity of fuels is calculated by compiling all of the GHG emissions emitted along the supply chain for a fuel, including all the emissions emitted in exploration, mining, collecting, producing, transporting, distributing, dispensing and burning the fuel.

In addition to reducing the carbon footprint and/or carbon intensity of agriculture production, in some embodiments, the subject invention can be used for reducing the number of carbon credits used by an operator involved in, e.g., agriculture, forestry/reforestation, and wetland management.

Advantageously, the systems of the subject invention can increase the efficiency and reduce the financial and environmental costs of agriculture practices. In particular, the compositions and methods utilized according to the subject invention can help in preserving valuable natural resources, such as soil and water, while improving production of valuable plant and animal-based commodities.

### Monitoring of Factors Such as Soil Moisture, Microbial Population, and GHG

In some embodiments, the systems of the subject invention further involve the monitoring of various inputs and outputs of crop production. For example, following application of a soil treatment composition to a tract of land, factors such as water usage, soil moisture content and dispersion, fertilizer usage, soil nutrient content and dispersion, cyanobacterial populations, soil organic carbon content, soil salinity, generation of GHG emissions or other atmospheric particulates, fossil fuel usage, and plant growth, health and yields can be monitored. Accordingly, the system can be adjusted throughout implementation to account for changes in these factors and make appropriate adjustments to the inputs.

In certain embodiments, the coverage of cyanobacterial biomass on soil substrates inoculated with one or more species of cyanobacteria can be assessed by the presence of chlorophyll a. The concentration of chlorophyll a can be representative of the amount of cyanobacterial biomass and/or location of the cyanobacterial biomass. The extraction of chlorophyll a from soil can be performed according to established methods, including methods described by Castle S C et al., (2011). Extraction of chlorophyll a from biological soil crusts: A comparison of solvents for spectrophotometric determination, Soil Biology and Biochemistry; 43(4): 853-856, which is hereby incorporated by reference in its entirety.

In some embodiments, monitoring comprises performing one or more measurements to assess the effect of the methods of the subject invention on the generation and/or reduction in generation of GHGs or other atmospheric particulates, and/or the accumulation of carbon and soil organic matter (SOM) in soil. In one embodiment, the method comprises simply measuring the depth of the soil profile, particularly of the soil crust, to determine whether the soil profile has decreased, increased, and/or remained stable after treatment with the subject compositions over time.

In certain embodiments, the measurements assess the effect of the methods of the subject invention on the generation and/or reduction in generation of GHGs or other atmospheric particulates and/or on the accumulation of SOC in plants and/or soil.

Measurements and/or monitoring can be conducted at a certain time point after application of the soil treatment composition to the site. In some embodiments, the measurements are conducted after about 1 week or less, 2 weeks or less, 3 weeks or less, 4 weeks or less, 30 days or less, 60 days or less, 90 days or less, 120 days or less, 180 days or less, 1 year or less and/or 2 years or less. In preferred embodiments, the measurements are conducted after each growing season of the crop plant.

Furthermore, the measurements and/or monitoring can be repeated over time. In some embodiments, the measurements are repeated daily, weekly, monthly, bi-monthly, semi-monthly, semi-annually, and/or annually.

In certain embodiments, assessing GHG generation can take the form of measuring GHG emissions from a site. Gas chromatography with electron capture detection is commonly used for testing samples in a lab setting. In certain embodiments, GHG emissions can also be conducted in the field, using, for example, flux measurements and/or in situ soil probing, Eddy Covariance Flux Towers, or other developing analytical tools, including, for example, a spectrometric system. Flux measurements analyze the emission of gases from the soil surface to the atmosphere, for example, using chambers that enclose an area of soil and then estimate flux by observing the accumulation of gases inside the chamber over a period of time. Probes can be used to generate a soil gas profile, starting with a measurement of the concentration of the gases of interest at a certain depth in the soil, and comparing it directly between probes and ambient surface conditions (Brummell and Siciliano, 2011).

Measuring GHG emissions can also comprise other forms of direct emissions measurement, gas chromatography-mass spectrometry (GC-MS) and/or analysis of fuel input. Direct emissions measurements can comprise, for example, identifying polluting operational activities (e.g., fuel-burning automobiles) and measuring the emissions of those activities directly through Continuous Emissions Monitoring Systems (CEMS). Fuel input analysis can comprise calculating the quantity of energy resources used (e.g., amount of electricity, fuel, wood, biomass, etc., consumed) determining the content of, for example, carbon, in the fuel source, and applying that carbon content to the quantity of the fuel consumed to determine the amount of emissions.

In certain embodiments, carbon content of a site where plants are growing, e.g., agricultural site, crop, sod or turf farm, pasture/prairie or forest, can be measured by, for example, quantifying the aboveground and/or below-ground biomass of plants. In general, the carbon concentration of, for example, a tree, is assumed to be from about 40 to 50% of the biomass.

Biomass quantification can take the form of, for example, harvesting plants in a sample area and measuring the weight of the different parts of the plant before and after drying. Biomass quantification can also be carried out using non-destructive, observational methods, such as measuring, e.g., trunk diameter, height, volume, and other physical parameters of the plant. Remote quantification can also be used, such as, for example, laser profiling and/or drone analysis.

In some embodiments, carbon content of a site can further comprise sampling and measuring carbon content of litter, woody debris and/or soil of a sampling area. Soil, in particular, can be analyzed, for example, using dry combustion to determine percent total organic carbon (TOC); by potassium permanganate oxidation analysis for detecting active carbon; and by bulk density measurements (weight per unit volume) for converting from percent carbon to tons/acre. Methods are also being developed and utilized to determine soil carbon by utilizing multispectral soil imaging by soil probes, satellite, drones or fixed wing aircraft.

In some embodiments, the aspects of the system can be centralized such that they are managed, facilitated and/or performed by a single entity. The entity can be a company or a person who manages, facilitates and/or performs all aspects of producing the microbial compositions, formulation and/or customization of the compositions, transportation and application of the compositions, and monitoring of inputs and outputs throughout the course of the treatment. The central entity can also utilize input and output data collected from a single customer and/or multiple customers to predict and formulate future adjustments to the prescribed agronomic or agricultural program.

In some embodiments, the central entity can serve as a general contractor, with sub-contractors performing one or more of the production, formulation/customization, transportation and application of the soil treatment compositions, as well as monitoring.

### Target Plants

The use of the cover crops can enhance the growth and/or productivity of target plants. As used here, the term “plant” includes, but is not limited to, any species of woody, ornamental or decorative, crop or cereal, fruit plant or vegetable plant, flower or tree, macroalga or microalga, phytoplankton and photosynthetic algae (e.g., green algae Chlamydomonas reinhardtii). “Plant” also includes a unicellular plant (e.g., microalga) and a plurality of plant cells that are largely differentiated into a colony (e.g., volvox) or a structure that is present at any stage of a plant's development. Such structures include, but are not limited to, a fruit, a seed, a shoot, a stem, a leaf, a root, a flower petal, etc. Plants can be standing alone, for example, in a garden, or can be one of many plants, for example, as part of an orchard, crop or pasture.

Types of crop plants that can benefit from application of the products and methods of the subject invention include, but are not limited to: row crops (e.g., corn, soy, sorghum, peanuts, potatoes, etc.), field crops (e.g., alfalfa, wheat, grains, etc.), tree crops (e.g., walnuts, almonds, pecans, hazelnuts, pistachios, etc.), citrus crops (e.g., orange, lemon, grapefruit, etc.), fruit crops (e.g., apples, pears, strawberries, blueberries, blackberries, etc.), turf crops (e.g., sod), ornamentals crops (e.g., flowers, vines, etc.), vegetables (e.g., tomatoes, carrots, etc.), vine crops (e.g., grapes, etc.), forestry (e.g., pine, spruce, eucalyptus, poplar, etc.), managed pastures (any mix of plants used to support grazing animals).

Additional examples of plants for which the subject invention is useful include, but are not limited to, cereals and grasses (e.g., wheat, barley, rye, oats, rice, maize, sorghum, corn), beets (e.g., sugar or fodder beets); fruit (e.g., grapes, strawberries, raspberries, blackberries, pomaceous fruit, stone fruit, soft fruit, apples, pears, plums, peaches, almonds, cherries or berries); leguminous crops (e.g., beans, lentils, peas or soya); oil crops (e.g., oilseed rape, mustard, poppies, olives, sunflowers, coconut, castor, cocoa or ground nuts); cucurbits (e.g., pumpkins, cucumbers, squash or melons); fiber plants (e.g., cotton, flax, hemp or jute); citrus fruit (e.g., oranges, lemons, grapefruit or tangerines); vegetables (e.g., spinach, lettuce, asparagus, cabbages, carrots, onions, tomatoes, potatoes or bell peppers); Lauraceae (e.g., avocado, Cinnamonium or camphor); and also tobacco, nuts, herbs, spices, medicinal plants, coffee, eggplants, sugarcane, tea, pepper, grapevines, hops, the plantain family, latex plants, cut flowers and ornamentals.

In certain embodiments, the crop plant is a citrus plant. Examples of citrus plants according to the subject invention include, but are not limited to, orange trees, lemon trees, lime trees and grapefruit trees. Other examples include Citrus maxima (Pomelo), Citrus medica (Citron), Citrus micrantha (Papeda), Citrus reticulata (Mandarin orange), Citrus paradisi (grapefruit), Citrus japonica (kumquat), Citrus australasica (Australian Finger Lime), Citrus australis (Australian Round lime), Citrus glauca (Australian Desert Lime), Citrus garrawayae (Mount White Lime), Citrus gracilis (Kakadu Lime or Humpty Doo Lime), Citrus inodora (Russel River Lime), Citrus warburgiana (New Guinea Wild Lime), Citrus wintersii (Brown River Finger Lime), Citrus halimii (limau kadangsa, limau kedut kera), Citrus indica (Indian wild orange), Citrus macroptera, and Citrus latipes, Citrus x aurantiifolia (Key lime), Citrus x aurantium (Bitter orange), Citrus x latifolia (Persian lime), Citrus x limon (Lemon), Citrus x limonia (Rangpur), Citrus x sinensis (Sweet orange), Citrus x tangerina (Tangerine), Imperial lemon, tangelo, orangelo, tangor, kinnow, kiyomi, Minneola tangelo, oroblanco, ugli, Buddha's hand, citron, bergamot orange, blood orange, calamondin, clementine, Meyer lemon, and yuzu.

In some embodiments, the crop plant is a relative of a citrus plant, such as orange jasmine, limeberry, and trifoliate orange (Citrus trifolata).

Additional examples of target plants include all plants that belong to the superfamily Viridiplantae, in particular monocotyledonous and dicotyledonous plants including fodder or forage legumes, ornamental plants, food crops, trees or shrubs selected from Acer spp., Actinidia spp., Abelmoschus spp., Agave sisalana, Agropyron spp., Agrostis stolonifera, Allium spp., Amaranthus spp., Ammophila arenaria, Ananas comosus, Annona spp., Apium graveolens, Arachis spp, Artocarpus spp., Asparagus officinalis, Avena spp. (e.g., A. sativa, A. fatua, A. byzantina, A. fatua var. sativa, A. hybrida), Averrhoa carambola, Bambusa sp., Benincasa hispida, Bertholletia excelsea, Beta vulgaris, Brassica spp. (e.g., B. napus, B. rapa ssp. [canola, oilseed rape, turnip rape]), Cadaba farinosa, Camellia sinensis, Canna indica, Cannabis sativa, Capsicum spp., Carex data, Carica papaya, Carissa macrocarpa, Carya spp., Carthamus tinctorius, Castanea spp., Ceiba pentandra, Cichorium endivia, Cinnamomum spp., Citrullus lanatus, Citrus spp., Cocos spp., Coffea spp., Colocasia esculenta, Cola spp., Corchorus sp., Coriandrum sativum, Corylus spp., Crataegus spp., Crocus sativus, Cucurbita spp., Cucumis spp., Cynara spp., Daucus carota, Desmodium spp., Dimocarpus longan, Dioscorea spp., Diospyros spp., Echinochloa spp., Elaeis (e.g., E. guineensis, E. oleifera), Eleusine coracana, Eragrostis tef, Erianthus sp., Eriobotrya japonica, Eucalyptus sp., Eugenia uniflora, Fagopyrum spp., Fagus spp., Festuca arundinacea, Ficus carica, Fortunella spp., Fragaria spp., Ginkgo biloba, Glycine spp. (e.g., G. max, Soja hispida or Soja max), Gossypium hirsutum, Helianthus spp. (e.g., H. annuus), Hemerocallis fulva, Hibiscus spp., Hordeum spp. (e.g., H. vulgare), Ipomoea batatas, Juglans spp., Lactuca sativa, Lathyrus spp., Lens culinaris, Linum usitatissimum, Litchi chinensis, Lotus spp., Luffa acutangula, Lupinus spp., Luzula sylvatica, Lycopersicon spp. (e.g., L. esculentum, L. lycopersicum, L. pyriforme), Macrotyloma spp., Malus spp., Malpighia emarginata, Mammea americana, Mangifera indica, Manihot spp., Manilkara zapota, Medicago sativa, Melilotus spp., Mentha spp., Miscanthus sinensis, Momordica spp., Morus nigra, Musa spp., Nicotiana spp., Olea spp., Opuntia spp., Ornithopus spp., Oryza spp. (e.g., O. sativa, O. latifolia), Panicum miliaceum, Panicum virgatum, Passiflora edulis, Pastinaca sativa, Pennisetum sp., Persea spp., Petroselinum crispum, Phalaris arundinacea, Phaseolus spp., Phleum pratense, Phoenix spp., Phragmites australis, Physalis spp., Pinus spp., Pistacia vera, Pisum spp., Poa spp., Populus spp., Prosopis spp., Prunus spp., Psidium spp., Punica granatum, Pyrus communis, Quercus spp. (e.g., Q. suber L), Raphanus sativus, Rheum rhabarbarum, Ribes spp., Ricinus communis, Rubus spp., Saccharum spp., Salix sp., Sambucus spp., Secale cereale, Sesamum spp., Sinapis sp., Solanum spp. (e.g., S. tuberosum, S. integrifolium or S. lycopersicum), Sorghum bicolor, Spinacia spp., Syzygium spp., Tagetes spp., Tamarindus indica, Theobroma cacao, Trifolium spp., Tripsacum dactyloides, Triticosecale rimpaui, Triticum spp. (e.g., T. aestivum, T. durum, T. turgidum, T. hybernum, T. macha, T. sativum, T. monococcum or T. vulgare), Tropaeolum minus, Tropaeolum majus, Vaccinium spp., Vicia spp., Vigna spp., Viola odorata, Vitis spp., Zea mays, Zizania palustris, Ziziphus spp., amongst others.

Target plants can also include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Target vegetable plants include tomatoes (Lycopersicon esculentum), lettuce (e.g., Lactuca sativa), green beans (Phaseolus vulgaris), lima beans (Phaseolus limensis), peas (Lathyrus spp.), and members of the genus Cucumis such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum. Conifers that may be employed in practicing the embodiments include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). Plants of the embodiments include crop plants (for example, corn, alfalfa, sunflower, Brassica, soybean, cotton, safflower, peanut, sorghum, wheat, millet, tobacco, etc.), such as corn and soybean plants.

Target turfgrasses include, but are not limited to: annual bluegrass (Poa annua); annual ryegrass (Lolium multiflorum); Canada bluegrass (Poa compressa); Chewings fescue (Festuca rubra); colonial bentgrass (Agrostis tenuis); creeping bentgrass (Agrostis palustris); crested wheatgrass (Agropyron desertorum); fairway wheatgrass (Agropyron cristatum); hard fescue (Festuca longifolia); Kentucky bluegrass (Poa pratensis); orchardgrass (Dactylis glomerate); perennial ryegrass (Lolium perenne); red fescue (Festuca rubra); redtop (Agrostis alba); rough bluegrass (Poa trivialis); sheep fescue (Festuca ovine); smooth bromegrass (Bromus inermis); tall fescue (Festuca arundinacea); timothy (Phleum pretense); velvet bentgrass (Agrostis canine); weeping alkaligrass (Puccinellia distans); western wheatgrass (Agropyron smithii); Bermuda grass (Cynodon spp.); St. Augustine grass (Stenotaphrum secundatum); zoysia grass (Zoysia spp.); Bahia grass (Paspalum notatum); carpet grass (Axonopus affinis); centipede grass (Eremochloa ophiuroides); kikuyu grass (Pennisetum clandesinum); seashore paspalum (Paspalum vaginatum); blue gramma (Bouteloua gracilis); buffalo grass (Buchloe dactyloids); sideoats gramma (Bouteloua curtipendula).

Further plants of interest include grain plants that provide seeds of interest, oil-seed plants, and leguminous plants. Seeds of interest include grain seeds, such as corn, wheat, barley, rice, sorghum, rye, millet, etc. Oil-seed plants include cotton, soybean, safflower, sunflower, Brassica, maize, alfalfa, palm, coconut, flax, castor, olive etc. Leguminous plants include beans and peas. Beans include guar, locust bean, fenugreek, soybean, garden beans, cowpea, mungbean, lima bean, fava bean, lentils, chickpea, etc. Further plants of interest include Cannabis (e.g., sativa, indica, and ruderalis) and industrial hemp.

All plants and plant parts can be treated in accordance with the invention. In this context, plants are understood as meaning all plants and plant populations such as desired and undesired wild plants or crop plants (including naturally occurring crop plants). Crop plants can be plants that can be obtained by traditional breeding and optimization methods or by biotechnological and recombinant methods, or combinations of these methods, including the transgenic plants and the plant varieties.

Plant tissue and/or plant parts are understood as meaning all aerial and subterranean parts and organs of the plants such as shoots, leaves, flowers, roots, needles, stalks, stems, fruits, seeds, tubers and rhizomes. The plant parts also include crop material and vegetative and generative propagation material, for example cuttings, tubers, rhizomes, slips and seeds.

### Soil Treatment Compositions

In certain embodiments, the subject invention provides soil treatment compositions comprising one or more soil-colonizing microorganisms and/or growth by-products thereof, such as exopolysaccharides and biosurfactants. The composition may also comprise the growth broth/medium in which the microorganism(s) were produced.

In some embodiments, the microorganisms of the subject invention have a greater CUE than microbes already present in the soil to which they are applied. In some embodiments, the microorganisms of the subject composition are “high CUE,” meaning the percentage of carbon they allocate to biomass production is greater than the percentage allocated to respiration.

In certain embodiments, the microorganisms are cyanobacteria. In some embodiments, the composition comprises more than one type and/or species of cyanobacteria. Advantageously, in some embodiments, the microorganisms colonize the soil.

In preferred embodiments, the microbe-based compositions according to the subject invention are non-toxic and can be applied in high concentrations without causing irritation to, for example, the skin or digestive tract of a human or other non-pest animal. Thus, the subject invention can be used where application of the microbe-based compositions occurs in the presence of living organisms, such as growers and livestock.

In one embodiment, multiple microorganisms can be used together, where the microorganisms create a synergistic beneficial effect on plant and/or soil health.

The species and ratio of microorganisms and other ingredients in the composition can be customized and optimized for specific local conditions at the time of application, such as, for example, which soil type, plant and/or crop is being treated; what season, climate and/or time of year it is when a composition is being applied; and what mode and/or rate of application is being utilized. Thus, the composition can be customizable for any given site.

The microorganisms useful according to the subject invention can be, for example, non-plant-pathogenic strains of cyanobacteria. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In one embodiment, the microorganism is a bacteria, particularly a cyanobacteria. Bacterial genera suitable for use according to the current invention, include Synechocystis, Synechococcus, Anabaena, Chroococcidiopsis, Cyanothece, Lyngbya, Phormidium, Nostoc, Spirulina, Arthrospira, Trichodesmium, Leptolyngbya, Plectonema, Myxosarcina, Pleurocapsa, Oscillatoria, Pseudanabaena, Cyanobacterium, Geitlerinema, Euhalothece, Calothrix, Tolypothrix, and Scytonema.

In certain embodiments, the microorganism is one that is capable of fixing nitrogen and/or other micronutrients in soil.

In a specific embodiment, the concentration of each microorganism included in the composition is 1×10⁶ to 1×10¹³ CFU/g, 1×10⁷ to 1×10¹² CFU/g, 1×10⁸ to 1×10¹¹ CFU/g, or 1×10⁹ to 1×10¹⁰ CFU/g of the composition.

In one embodiment, the total microbial cell concentration of the composition is at least 1×10⁶ CFU/g, including up to 1×10⁹ CFU/g, 1×10¹⁰, 1×10¹¹, 1×10¹² and/or 1×10¹³ or more CFU/g. In one embodiment, the microorganisms of the subject composition comprise about 5 to 20% of the total composition by weight, or about 8 to 15%, or about 10 to 12%.

The composition can comprise the leftover growth substrate and, optionally, unpurified growth by-products, such as exopolysaccharides and biosurfactants. The microbes can be live or inactive.

The microorganisms in the composition may be in an active or inactive form, or in the form of vegetative cells, spores, heterocysts or any other form. The composition may also contain a combination of any of these microbial forms.

In one embodiment, when a combination of strains of microorganism are included in the composition, the different strains of microbe are grown separately and then mixed together to produce the composition.

Advantageously, in accordance with the subject invention, the composition may comprise the medium in which the microbes were grown. The composition may be, for example, at least, by weight, at least about 1%, about 5%, about 10%, about 25%, about 50%, about 75%, or about 99% growth medium. The amount of biomass in the composition, by weight, may be, for example, anywhere from about 0.01% to about 100% inclusive of all percentages therebetween.

In one embodiment, the composition is preferably formulated for application to soil, seeds, whole plants, or plant parts (including, but not limited to, roots, tubers, stems, flowers and leaves). In certain embodiments, the composition is formulated as, for example, liquid, dust, granules, microgranules, pellets, wettable powder, flowable powder, emulsions, microcapsules, oils, or aerosols.

Further components can be added to the composition, for example, adjuvants, buffering agents, carriers, other microbe-based compositions produced at the same or different facility, viscosity modifiers, preservatives, nutrients for microbe growth, tracking agents, biocides, other microbes, surfactants, emulsifying agents, lubricants, solubility controlling agents, pH adjusting agents, preservatives, and stabilizers.

The pH of the composition should be suitable for the microorganism of interest as well as for the soil environment to which it will be applied. In some embodiments, the pH is about 2.0 to about 10.0, about 2.0 to about 9.5, about 2.0 to about 9.0, about 2.0 to about 8.5, about 2.0 to about 8.0, about 2.0 to about 7.5, about 2.0 to about 7.0, about 3.0 to about 7.5, about 4.0 to about 7.5, about 5.0 to about 7.5, about 5.5 to about 7.0, about 6.5 to about 7.5, or about 7.1. Buffers, and pH regulators, such as carbonates and phosphates, may be used to stabilize pH near a preferred value.

Optionally, the composition can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

The microbe-based compositions may be used without further stabilization, preservation, and storage, however. Advantageously, direct usage of these microbe-based compositions preserves a high viability of the microorganisms, reduces the possibility of contamination from foreign agents and undesirable microorganisms, and maintains the activity of the by-products of microbial growth.

In other embodiments, the composition (microbes, growth medium, or microbes and medium) can be placed in containers of appropriate size, taking into consideration, for example, the intended use, the contemplated method of application, the size of the growth vessel, and any mode of transportation from microbe growth facility to the location of use. Thus, the containers into which the microbe-based composition is placed may be, for example, from 1 pint to 1,000 gallons or more. In certain embodiments the containers are 1 gallon, 2 gallons, 5 gallons, 25 gallons, or larger.

The compositions can be used in combination with other agricultural compounds and/or crop management systems. In one embodiment, the composition can optionally comprise, or be applied with, for example, natural and/or chemical pesticides, repellants, herbicides, fertilizers, water treatments, non-ionic surfactants and/or soil amendments. Preferably, however, the composition does not comprise and/or is not used with antibiotics, benomyl, dodecyl dimethyl ammonium chloride, hydrogen dioxide/peroxyacetic acid, imazilil, propiconazole, tebuconazole, or triflumizole.

If the composition is mixed with compatible chemical additives, the chemicals are preferably diluted with water prior to addition of the subject composition.

In one embodiment, the subject compositions are compatible for use with agricultural compounds characterized as antiscalants, such as, for example, hydroxyethylidene diphosphonic acid; fertilizers, such as, e.g., N-P-K fertilizers, calcium ammonium nitrate 17-0-0, potassium thiosulfate, nitrogen (e.g., 10-34-0, Kugler KQ-XRN, Kugler KS-178C, Kugler KS-2075, Kugler LS 6-24-6S, UN 28, UN 32), and/or potassium; fungicides, such as, for example, chlorothalonil, manicozeb hexamethylenetetramine, aluminum tris, azoxystrobin, Bacillus spp. (e.g., B. licheniformis strain 3086, B. subtilis, B. subtilis strain QST 713), benomyl, boscalid, pyraclostrobin, captan, carboxin, chloroneb, chlorothalonil, copper sulfate, cyazofamid, dicloran, dimethomorph, etridiazole, thiophanate-methyl, fenamidone, fenarimol, fludioxonil, fluopicolide, flutolanil, iprodione, mancozeb, maneb, mefanoxam, fludioxonil, mefenoxam, metalaxyl, myclobutanil, oxathiapiprolin, pentachloronitrobenzene (quintozene), phosphorus acid, propamocarb, propanil, pyraclostrobin, Reynoutria sachalinensis, Streptomyces spp. (e.g., S. griseoviridis strain K61, S. lydicus WYEC 108), sulfur, urea, thiabendazole, thiophanate methyl, thiram, triadimefon, triadimenol, and/or vinclozolin; growth regulators, such as, e.g., ancymidol, chlormequat chloride, diaminozide, paclobutrazol, and/or uniconazole; herbicides, such as, e.g., glyphosate, oxyfluorfen, and/or pendimethalin; insecticides, such as, e.g., acephate, azadirachtin, B. thuringiensis (e.g., subsp. israelensis strain AM 65-52), Beauveria bassiana (e.g., strain GHA), carbaryl, chlorpyrifos, cyantraniliprole, cyromazine, dicofol, diazinon, dinotefuran, imidacloprid, Isaria fumosorosae (e.g., Apopka strain 97), lindane, and/or malathion; adjuvants; surfactants; water treatments, such as, for example, glycolipids, lipopeptides, deet, diatomaceous earth, citronella, essential oils, mineral oils, garlic extract, chili extract, and/or any known commercial and/or homemade pesticide that is determined to be compatible by the skilled artisan having the benefit of the subject disclosure.

Preferably, the composition does not comprise and/or is not applied simultaneously with, or within 7 to 10 days before or after, application of the following compounds: antibiotics, benomyl, dodecyl dimethyl ammonium chloride, hydrogen dioxide/peroxyacetic acid, imazilil, propiconazole, tebuconazole, or triflumizole.

### Growth of Microbes According to the Subject Invention

The subject invention utilizes methods for cultivation of microorganisms. The subject invention further utilizes cultivation processes that are suitable for cultivation of microorganisms on a desired scale. These cultivation processes include, but are not limited to, open pond cultivation, including, for example, round or raceway ponds. The ponds can be outdoor ponds or indoor ponds.

The microbe growth vessel used according to the subject invention can also be any closed system, including, for example, a cultivation reactor for industrial or small-scale use. In one embodiment, the vessel may have functional controls/sensors or may be connected to functional controls/sensors to measure important factors in the cultivation process, such as pH, oxygen, carbon dioxide concentration, pressure, temperature, humidity, light intensity, microbial density and/or metabolite concentration. In certain embodiments, the growth vessels can be at the site of application.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, atmospheric nitrogen (N₂), sodium nitrate, cobalt nitrate, potassium nitrate, ammonium nitrate, ammonium sulfate, ammonium phosphate, ammonia, urea, and/or ammonium chloride. These nitrogen sources may be used independently or in a combination of two or more.

The method can further comprise supplementing the cultivation with a carbon source. The carbon source can be carbon dioxide; a carbohydrate, such as arabinose, glucose, sucrose, lactose, fructose, trehalose, mannose, mannitol, and/or maltose. These carbon sources may be used independently or in a combination of two or more. In certain embodiments, humates and/or kelps can be used as supplements.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, copper sulfate, calcium chloride, sodium chloride, calcium carbonate, and/or sodium carbonate. These inorganic salts may be used independently or in a combination of two or more.

In one embodiment, specific nutrients are added to and/or applied concurrently with the microbe-based product to enhance microbial inoculation and growth. These can include, for example, nitrates, sulfates, potassium, calcium, sodium, magnesium, sulfur, boron, iron, manganese, molybdenum, copper, cobalt, and/or zinc. The nutrients can be derived from, for example, sodium nitrate, dipotassium phosphate, magnesium sulfate, calcium chloride, citric acid, ferric ammonium citrate, EDTA disodium salt, sodium carbonate, boric acid, manganese chloride, zinc sulfate, sodium molybdate, copper sulfate, and/or cobalt nitrate.

In certain embodiments, the growth medium is BG-11 (see Allen M M, Stanier R Y. Selective isolation of blue-green algae from water and soil. Microbiology. 1968;51:203-9.).

In certain embodiments, the cyanobacteria are exposed to a light intensity of at least about 1000 lux, about 1000 lux to about 120,000 lux (e.g., bright sunlight), about 2,000 lux to about 5,000 lux, or about 2,000 lux to about 3,000 lux. In certain embodiments, the cyanobacteria are exposed to the light for at least about 6 hours, about 8 hours, about 12 hours, about 18 hours, or about 24 hours per day.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state.

The pH of the culture should be suitable for the microorganism of interest as well as for the soil environment to which the composition will be applied. In some embodiments, the pH is about 2.0 to about 10.0, about 2.0 to about 9.5, about 2.0 to about 9.0, about 2.0 to about 8.5, about 2.0 to about 8.0, about 2.0 to about 7.5, about 2.0 to about 7.0, about 3.0 to about 7.5, about 4.0 to about 7.5, about 5.0 to about 7.5, about 5.5 to about 7.0, about 6.5 to about 7.5, or about 7.1. Buffers, and pH regulators, such as carbonates and phosphates, may be used to stabilize pH near a preferred value.

In one embodiment, the method of cultivation is carried out at about 5° to about 100° C., about 15° to about 60° C., about 20° to about 50° C., about 20° to about 45° C., about 25° to about 40° C., about 25° to about 37° C., about 25° to about 35° C., about 30° to about 35° C., or about 30° C. In one embodiment, the cultivation may be carried out continuously at a constant temperature. In another embodiment, the cultivation may be subject to changing temperatures.

In one embodiment, the equipment used in the method and cultivation process is sterile. The cultivation equipment such as the pond/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the growth medium may be sterilized.

In one embodiment, the subject invention further provides a method for producing microbial metabolites such as, for example, exopolysaccharides and biosurfactants, by cultivating a microbe strain of the subject invention under conditions appropriate for growth and metabolite production. The metabolite content produced by the method can be, for example, at least 0.0001%, 0.001%, 0.01%, 0.1%, 1%, 5%, 10%, or 20%.

The microbial growth by-product produced by microorganisms of interest may be retained in the microorganisms or secreted into the growth medium. The medium may contain compounds that stabilize the activity of microbial growth by-product.

The cell concentration may be, for example, at least 1×10⁶ to 1×10¹³, 1×10⁷ to 1×10¹², 1×10⁸ to 1×10¹¹, or 1×10⁹ to 1×10¹⁰ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the growth product is removed at any one time. In this embodiment, biomass with viable cells, spores, or heterocysts remains in the vessel as an inoculant for a new cultivation batch. The composition that is removed can contain cells, spores, heterocysts, or any combination of thereof. In this manner, a quasi-continuous system is created.

Advantageously, the method does not require complicated equipment or high energy consumption. The microorganisms of interest can be cultivated at small or large scale on site and utilized.

Advantageously, the microbe-based products can be produced in remote locations. The microbe growth facilities may operate off the grid by utilizing, for example, solar, wind and/or hydroelectric power.

### Preparation of Microbe-Based Products

One microbe-based product of the subject invention is simply the growth medium containing the microorganisms and, optionally, the microbial metabolites produced by the microorganisms and/or any residual nutrients. The product of growth may be used directly without extraction or purification.

The microorganisms in the microbe-based products may be in an active or inactive form, or in the form of vegetative cells, spores, heterocysts, or any other form. The microbe-based products may also contain a combination of any of these forms of a microorganism.

In one embodiment, different species or strains of cyanobacteria are grown separately and then mixed together to produce the microbe-based product. The microbes can, optionally, be blended with the medium in which they are grown and dried prior to mixing. In certain embodiments, the microbes can be dried during the preparation process. In certain embodiments, the microbes can be applied to the soil after being dried. In certain embodiments, the microbes can be mixed with a water-based solution before being applied to soil.

In one embodiment, the different strains are not mixed together, but are applied soil as separate microbe-based products.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, other microbes and other suitable additives that are customarily used for such preparations.

In one embodiment, buffering agents including organic and amino acids or their salts, can be added. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

In one embodiment, additional components such as an aqueous preparation of a salt, such as sodium bicarbonate or carbonate, sodium sulfate, sodium phosphate, sodium biphosphate, can be included in the formulation.

In one embodiment, specific nutrients are added to and/or applied concurrently with the microbe-based product to enhance microbial inoculation and growth. These can include, for example, nitrates, sulfates, potassium, calcium, sodium, magnesium, sulfur, boron, iron, manganese, molybdenum, copper, cobalt, and/or zinc. The nutrients can be derived from, for example, sodium nitrate, dipotassium phosphate, magnesium sulfate, calcium chloride, citric acid, ferric ammonium citrate, EDTA disodium salt, sodium carbonate, boric acid, manganese chloride, zinc sulfate, sodium molybdate, copper sulfate, and/or cobalt nitrate.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

### REFERENCES

Allen M M, Stanier R Y. Selective isolation of blue-green algae from water and soil. Microbiology. 1968;51:203-9.

Brummell M E and Siciliano S D. Measurement of Carbon Dioxide, Methane, Nitrous Oxide, and Water Potential in Soil Ecosystems. Methods in Enzymology. 2011; 496:115-137. Doi: 10.1016/B978-0-12-386489-5.00005-1.

Castle S C, Morrison C D, Barger N N. Extraction of chlorophyll a from biological soil crusts: A comparison of solvents for spectrophotometric determination, Soil Biology and Biochemistry. 43 (4): 2011, Pages 853-856.

Muñoz-Rojas M, Román J R, Roncero-Ramos B, Erickson T E, Merritt D J, Aguila-Carricondo P, Cantón Y. Cyanobacteria inoculation enhances carbon sequestration in soil substrates used in dryland restoration. Sci Total Environ. 2018 Sep. 15;636:1149-1154. doi: 10.1016/j.scitotenv.2018.04.265. Epub 2018 May 4. PMID: 29913577.

Roman J R, Roncero-Ramos B, Chamizo S, Rodríguez-Caballero E, Cantón Y. Restoring soil functions by means of cyanobacteria inoculation: Importance of soil conditions and species selection. Land Degrad Dev. 2018; 29: 3184-3193.

We claim:

1. A method for:
1. Enhancing plant health, growth and/or yields;
2. Enhancing soil health through rebuilding of degraded soils and/or preventing degradation of soils;
3. Reducing atmospheric greenhouse gas or particulate emissions;
4. Enhancing soil sequestration of carbon;
5. Reducing fertilizer usage and/or runoff;
6. Reducing soil erosion;
7. Reducing the intensity and/or frequency of dust storms;
8. Enhancing atmospheric nitrogen fixation,
9. Enhancing phosphate solubility,
10. Enhancing microbial growth and nutrient cycling,
11. Enhancing soil moisture retention and precipitation/irrigation percolation,
12. Reducing water run-off,
13. Reducing atmospheric particulates,
14. Reducing soil salinity,
15. Enhancing soil aggregate formation,
16. Reducing the use of traditional cover crops,
17. Reducing soil compaction,
18. Enhancing breakdown of pesticide and herbicide residues, and/or
19. Reducing dust generated by agricultural operations,
wherein the method comprises applying a soil treatment composition comprising one or more soil-colonizing microorganisms, and/or a growth by-product thereof, to soil, wherein the one or more microorganisms are selected from Synechocystis spp., Synechococcus spp., Anabaena spp., Chroococcidiopsis spp., Cyanothece spp., Lyngbya spp., Phormidium spp., Nostoc spp., Spirulina spp., Arthrospira spp., Trichodesmium spp., Leptolyngbya spp., Plectonema spp., Myxosarcina spp., Pleurocapsa spp., Oscillatoria spp., Pseudanabaena spp., Geitlerinema spp., Euhalothece spp., Calothrix spp., Tolypothrix spp. and Scytonema spp.

2. The method of claim 1, wherein the said one or more microorganisms is applied to the soil in the off-season of a crop plant.

3. The method of claim 1, wherein the said one or more microorganisms is grown instead of a crop plant.

4. The method of claim 1, wherein the said one or more microorganisms is grown with a crop plant.

5. The method of claim 1, wherein the soil treatment composition comprises growth medium and the microorganism in which the one or more microorganisms were cultivated.

6. The method of claim 1, wherein the soil treatment composition comprises Nostoc spp., Spirulina spp., Tolypothrix spp., Anabaena spp., or any combination thereof.

7. The method of claim 1, wherein the soil is dryland, desert, low fertility soil, or rangeland.

8. The method of claim 1, wherein the microbial growth by-product is an exopolysaccharide, biosurfactant, or combination thereof.

9. The method of claim 1, wherein the soil treatment composition is applied in the form of a liquid culture.

10. The method of claim 1, wherein the soil treatment composition is applied in the form of a dry culture.

11. The method of claim 10, wherein the dry coating is a prill or seed coating.

12. The method of claim 1, wherein the one or more microorganisms are mixed with water prior to application.

13. The method of claim 12, wherein the one or more microorganisms are dried before mixed with water.

14. The method of claim 1, wherein the one or more microorganisms are applied to soil using an irrigation system.

15. The method of claim 1, wherein the one or more microorganisms are applied to soil using an aerial sprayer.

16. The method of claim 1, wherein the one or more microorganisms are applied to soil using a ground application method.

17. The method of claim 1, wherein the ground application method is foliar, drench, or injection.

18. The method of claim 1, wherein the one or more microorganisms are applied to soil contemporaneously with a source of one or more nutrients selected from carbon, nitrogen, sodium, magnesium, phosphorous, potassium, calcium, iron, molybdenum, manganese, or any combination thereof.

19. The method of claim 1, further comprising monitoring one or more of soil moisture content, microbial populations, soil organic matter (SOM), soil salinity, soil aggregate formation, water table levels, nutrient content, and GHG emissions at the location of application.

20. The method of claim 19, wherein the microbial populations are monitored by measuring the concentration of chlorophyll a in a soil sample.
